(19) United States
(12) Patent Application Publication
(10) Pub. No.: US 2017/0003859 A1
(43) Pub. Date: Jan. 5, 2017

(54) METHOD FOR ONE-HANDED OPERATION ON ELECTRONIC DEVICE AND ASSOCIATED ELECTRONIC DEVICE

(71) Applicant: MEDIATEK INC., Hsin-Chu (TW)

(72) Inventor: Hao-Liang Yang, Pingtung County (TW)

(21) Appl. No.: 14/754,723

(22) Filed: Jun. 30, 2015

(51) Int. Cl. G06F 3/0484; G06F 3/0489; G06F 3/0488; G06F 3/01; G06F 3/0346

(52) U.S. Cl. CPC G06F 3/04845; G06F 3/017; G06F 3/0346; G06F 3/04886; G06F 3/013; G06F 3/0489; G06F 3/04883; G06F 2203/04803

(57) ABSTRACT

A method of controlling an electronic device includes: displaying a first content on a first viewable display area in a display screen of the electronic device; receiving a user command; setting a second viewable display area by adjusting the first viewable display area in response to the user command, wherein a size of the second viewable display area is different from a size of the first viewable display area; deriving a second content by adjusting a layout of the first content; and displaying the second content on the second viewable display area in the display screen of the electronic device.

### BACKGROUND

The present disclosure relates to touch input devices, and more particularly, to a user interface adjusting method applicable to an electronic device with a touch screen.

As smartphone screen sizes grow, operations such as clicking website links, playing games and inputting texts become difficult to perform one-handed. A user may operate a smartphone by utilizing the right palm to hold the back cover and the thumb of the right hand to slide/click the touch screen. FIG. 1 is a diagram illustrating the physical boundary of one-handed operations upon a typical large-sized smartphone 100, wherein the size of the smartphone 100 may be over 6 inches. As shown in FIG. 1, due to the limit of the physical range, some parts of the smartphone 100, such as some buttons of the virtual keyboard area 110 and some parts of the multimedia content area, may be unreachable, thus increasing the difficulty of performing one-handed operations. When a user grabs the smartphone 100 with his/her hand and performs a sliding operation upon the virtual keyboard 110 area and/or the multimedia content area 120 with his/her thumb at the same time, wherein the curve 70 denotes an operation boundary of the thumb when the user is performing one-hand operations, it can be observed that there is still a huge unreachable area.

FIG. 2 is a diagram illustrating the physical boundary of one-handed operations upon a typical small-sized smartphone 200, wherein the size of the smartphone 200 may be about 4 inches and has an elongated shape, and the curve 270 denotes the operation boundary of a thumb when the user is performing one-handed operations upon the smartphone 200. As shown in FIG. 2, the curve 270 covers most part of the multimedia content area 220 and the whole virtual keyboard area 210. Compared to the scenario of FIG. 1, the smartphone 200 shown in FIG. 2 is much more suitable for one-handed operations. The long-thin view of the smartphone 200 may lower the user experience, however, due to the length-to-width ratio, particularly when being used for entertainment (viewing videos, etc.). In other words, the smartphone 200 is less than ideal in many scenarios and has obvious drawbacks such as the distortion of the view. Although the mechanical structure of the smartphone 200 is friendly for one-handed operation, the long-thin view thereof may be visually unfriendly.

Therefore, there is a need for a novel software/firmware design for large-sized smartphones, to solve the above issues.

### SUMMARY

An objective of the present disclosure is to provide a method of controlling an electronic device and an associated electronic to solve the aforementioned problems. The present disclosure may make points of interest of content shown in a viewable display area more touchable/operable when the user is performing one-handed operations.

According to a first aspect of the present disclosure, a method of controlling an electronic device is provided. The method includes: displaying a first content on a first viewable display area in a display screen of the electronic device; receiving a user command; setting a second viewable display area by adjusting the first viewable display area in response to the user command, wherein a size of the second viewable display area is different from a size of the first viewable display area; deriving a second content by adjusting a layout of the first content; and displaying the second content on the second viewable display area in the display screen of the electronic device.

According to a second aspect of the present disclosure, a method of controlling an electronic device is provided. The method includes: displaying a first content on a display screen of the electronic device; receiving a user command; deriving a second content by adjusting a layout of the first content in response to the user command, wherein the second content is a mirrored version of the first content, a distorted version of the first content, or the first content with a floating window overlapped thereon, where a content of the floating window is a down-scaled version of at least a portion of the first content; and displaying the second content on the display screen of the electronic device.

According to a third aspect of the present disclosure, an electronic device is provided. The electronic device includes a display screen, a receiving circuit and a controller. The display screen is arranged to display a first content on a first viewable display area or a second content on a second viewable display area. The receiving circuit is arranged to receive a user command. The controller is arranged to set a second viewable display area by adjusting the first viewable display area in response to the user command. A size of the second viewable display area is different from a size of the first viewable display area. The controller derives the second content by adjusting a layout of the first content, and controls the display screen to display the second content on the second viewable display area in the display screen of the electronic device instead of displaying the first content on the first viewable display area in the display screen of the electronic device.

According to a fourth aspect of the present disclosure, an electronic device is provided. The electronic device includes a display screen, a receiving circuit and a controller. The display screen is arranged to display a first content on a first viewable display area or a second content on a second viewable display area. The receiving circuit is arranged to receive a user command. The controller is arranged to derive a second content by adjusting a layout of the first content in response to the user command, wherein the second content is a mirrored version of the first content, a distorted version of the first content, or the first content with a floating window overlapped thereon, where a content of the floating window is a down-scaled version of at least a portion of the first content. The controller controls the display screen to display the second content on the second viewable display area in the display screen of the electronic device instead of displaying the first content on the first viewable display area in the display screen of the electronic device.

These and other objectives of the present disclosure will no doubt become obvious to those of ordinary skill in the art after reading the following detailed description of the implementations that are illustrated in the various figures and drawings.

### BRIEF DESCRIPTION OF THE DRAWINGS

FIG. 1 is a diagram illustrating the physical boundary of one-handed operations upon a typical large-sized smartphone.

FIG. 2 is a diagram illustrating the physical boundary of one-handed operations upon a typical small-sized smartphone.

FIG. 3 is a diagram illustrating an electronic device according to a first implementation of the present disclosure.

FIG. 4 is a diagram illustrating a scenario of generating a user command on the electronic device shown in FIG. 3 according to a first implementation of the present disclosure.

FIG. 5 is a diagram illustrating the first content displayed on the first viewable display area of the electronic device shown in FIG. 3.

FIG. 6 is a diagram illustrating the second content displayed on the second viewable display area of the electronic device shown in FIG. 3.

FIG. 7 is a diagram illustrating a scenario of displaying the second content on the electronic device shown in FIG. 3 based on the first content shown in FIG. 5 according to a second implementation of the present disclosure.

FIG. 8 is a diagram illustrating a scenario of displaying the second content on the electronic device shown in FIG. 3 based on the first content shown in FIG. 5 according to a third implementation of the present disclosure.

FIG. 9 is a diagram illustrating a scenario of displaying the second content on the electronic device shown in FIG. 3 based on the first content shown in FIG. 5 according to a fourth implementation of the present disclosure.

FIG. 10 is a diagram illustrating a scenario of generating a user command on the electronic device shown in FIG. 3 according to a fifth implementation of the present disclosure.

FIG. 11 is a diagram illustrating a scenario of generating a user command on an electronic device according to a sixth implementation of the present disclosure.

FIG. 12 is a diagram illustrating a scenario of generating a user command on the electronic device shown in FIG. 3 according to a seventh implementation of the present disclosure.

FIG. 13 is a diagram illustrating a scenario of displaying a floating window on the electronic device shown in FIG. 3 based on the first content shown in FIG. 5 according to an eighth implementation of the present disclosure.

FIG. 14 is a flowchart illustrating a method of controlling an electronic device according to an implementation of the present disclosure.

FIG. 15 is a flowchart illustrating a method of controlling an electronic device according to another implementation of the present disclosure.

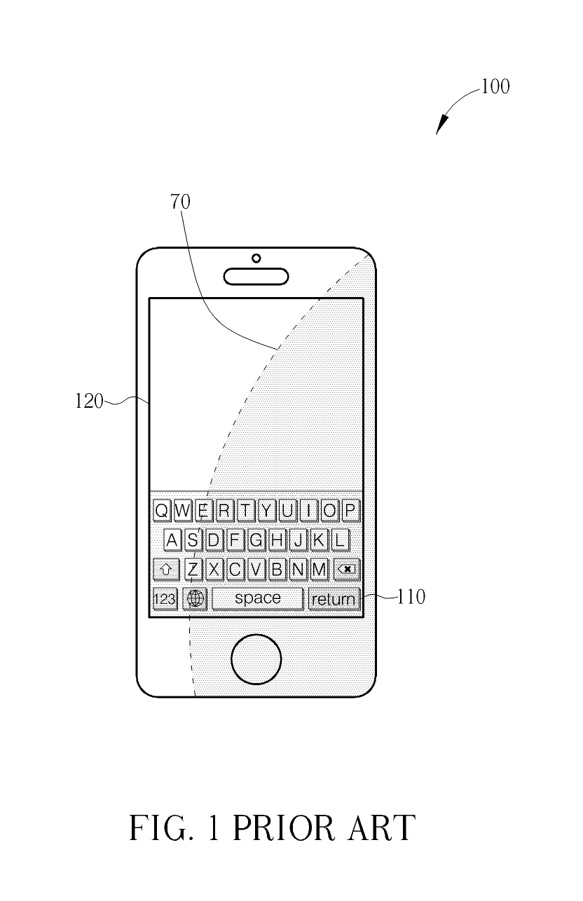

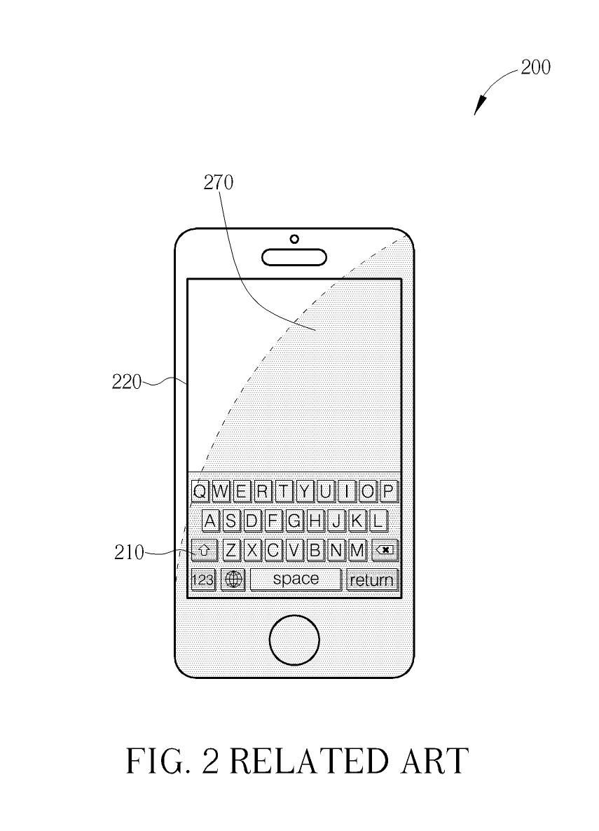

### DETAILED DESCRIPTION

Certain terms may be used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” may be used in an open-ended fashion, and thus should be interpreted to mean “include, but not limited to . . . ”. Also, the term “couple” may be intended to mean either an indirect or direct electrical connection. Accordingly, if one device is coupled to another device, that connection may be through a direct electrical connection, or through an indirect electrical connection via other devices and connections.

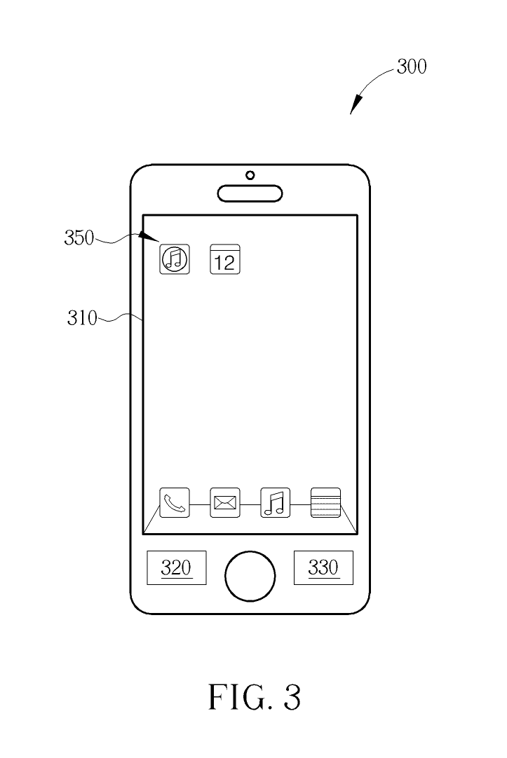

FIG. 3 is a diagram illustrating an electronic device 300 according to a first implementation of the present disclosure. By means of illustration, but not limitation, the electronic device 300 may include a display screen 310, a receiving circuit 320 and a controller 330. For clarity and simplicity, the receiving circuit 320 and the controller 330 are illustrated in the bottom space of the electronic device 300. In practice, the receiving circuit 320 and the controller 330 may be installed on a circuit board inside the housing of the electronic device 300. The display screen 310 may be arranged to display a content 350 on a predetermined viewable display, for example the full screen area. For better understanding, the electronic device 300 may be a smartphone or a tablet, and the display screen 310 may be a touch screen; however, the present disclosure is not limited thereto.

The receiving circuit 320 may be arranged to receive a user command. The user command may be triggered/generated by touch, gesture, tilting, eye detection and/or voice operations, wherein the touch operations maybe generated by an object (e.g. the user's finger) being in contact with or close to an input device (e.g. touch panel). After the receiving circuit 320 receives the user command, the controller 330 may accordingly convert the current image (i.e. the full screen image) into a resized/down-scaled version or a distorted version of the current image. After that, the processed image will be displayed on an area smaller than the full screen area. This is not a limitation; in some implementations, the size of the processed image may be identical to the size of the full screen area.

The controller 330 may be arranged to set the second viewable display area by adjusting the first viewable display area in response to the user command. More particularly, the second viewable display area may be smaller than the first viewable display area, so that the user may more easily touch points of interest when performing one-handed operations.

The controller 330 may derive the second content by adjusting the layout of the first content, and control the display screen 310 to display the second content on the second viewable display area on the display screen 310 of the electronic device 300 instead of displaying the first content on the first viewable display area in the display screen 310 of the electronic device 300. After the controller 330 performs the aforementioned image resize/re-layout operations, the points of interest shown on the content of the display screen 310 become touchable when the user is performing one-handed operations. The detailed methods for generating user commands are illustrated as follows.

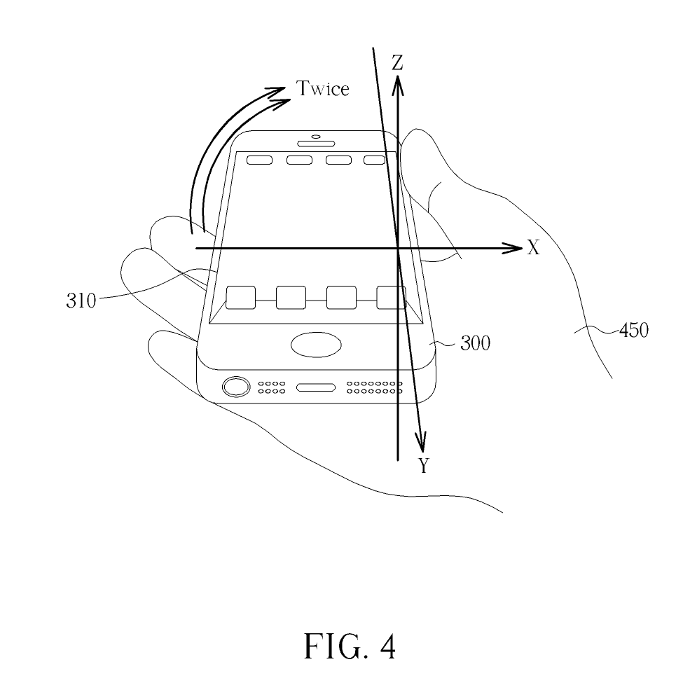

FIG. 4 is a diagram illustrating a scenario of generating a user command on the electronic device 300 shown in FIG. 3 according to a first implementation of the present disclosure. In this implementation, the user command may be triggered when the electronic device 300 receives a gesture input. Further, the user command may be identified according to the gesture detection result. As shown in FIG. 4, a tilting operation upon the electronic device 300 may be detected along a predetermined axis. In this implementation, the predetermined axis may represent a length of the electronic device 300. The user may rapidly flip the electronic device 300 along the y-axis twice to generate an image adjusting command, wherein the y-axis shown in FIG. 4 may denote the length of the electronic device 300, the x-axis shown in FIG. 4 may denote the width of the electronic device 300, the z-axis shown in FIG. 4 may denote the height of the electronic device 300, and the x-axis, y-axis and z-axis may be perpendicular to one another. In this implementation, the electronic device 300 may be laid horizontally on the palm 450 of the user. The present disclosure does not require that the electronic device 300 has to be laid flat to generate the user command, however.

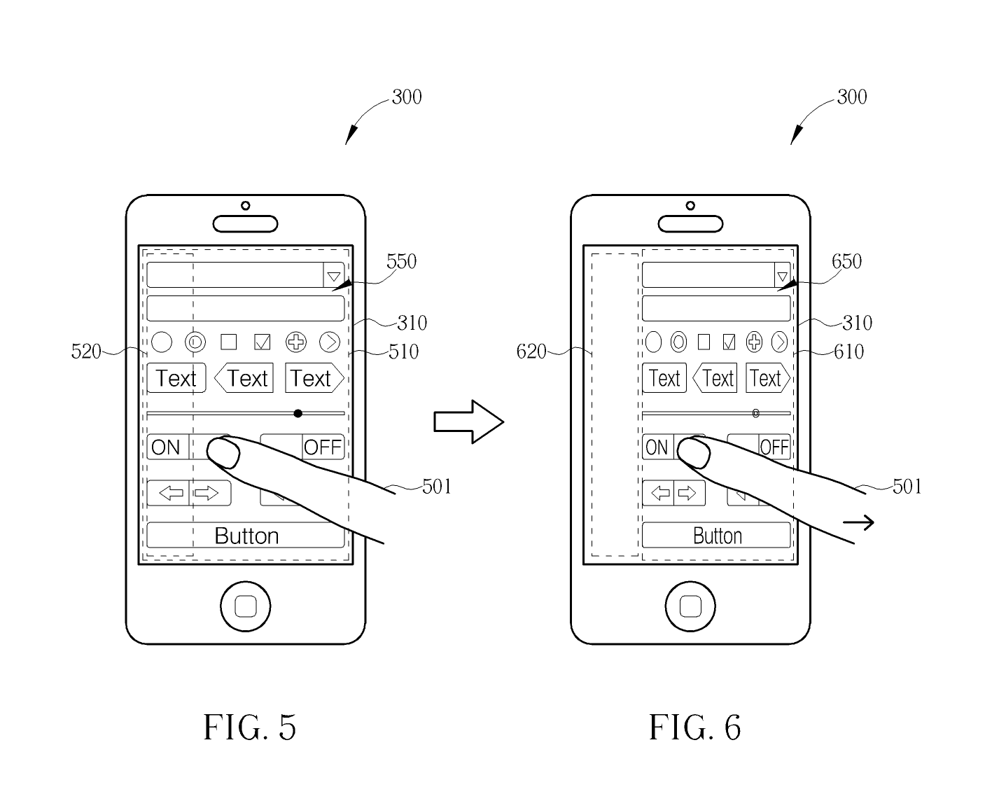

Examples of the aforementioned unadjusted image (e.g. the first content) and the adjusted image (e.g. the second content) are illustrated in FIGS. 5 and 6, respectively. FIG. 5 is a diagram illustrating the first content 550 displayed on the first viewable display area 510 of the electronic device 300 (more particularly, the display screen 310) shown in FIG. 3, and FIG. 6 is a diagram illustrating the second content 650 displayed on the second viewable display area 610 of the electronic device 300 shown in FIG. 3. As can be seen from FIG. 5, the area 520 is difficult to be touched by the thumb 501 when the user holds the electronic device 300 on one hand. This issue can be solved by applying the scenario shown in FIG.

6.

In FIG. 6, the second content 650 may be displayed in the second viewable display area 610, wherein the second content 650 may be a resized version (e.g. a narrowed or distorted version) of the first content 550. More specifically, this implementation may adjust the layout of the first content 550 by resizing the first content along the width (x-axis) of the electronic device 300. In this way, it is much easier for the user to perform one-handed operations with the thumb 501 for all content in the second viewable display area 610 while holding the electronic device 300 in one hand.

Further, when the display screen 310 displays the second content 650 instead of the first content 550, the area 620 may be left blank or utilized to show additional information (such as texts, pictures and/or weather forecast messages), wherein the first viewable display area 510 can be viewed as a summation of the second viewable display area 610 and the area 620.

Although the implementations of the present disclosure focus on adjusting (e.g. shrinking) the width of the image, the present disclosure is not limited thereto. In some implementations, the second content may be generated by adjusting (e.g. shrinking) the length of the first content rather than the width of the first content. In some implementations, the second content may be generated by adjusting (e.g. shrinking) both the length and width of the first content. Since one skilled in the art should readily know the implementations of resizing both the length and width of the first content after reading the above implementations, the detailed illustrations thereof are omitted here for brevity.

Moreover, the present disclosure is not limited to the resizing operation shown in FIG. 6. In some implementations, the resizing operation shown in FIG. 6 may be replaced with another operation, such as a mirroring operation, a distorting operation or an operation used for generating a floating window, to enable the user to more easily perform one-handed operations. The detailed implementations of these alternative schemes are illustrated as follows.

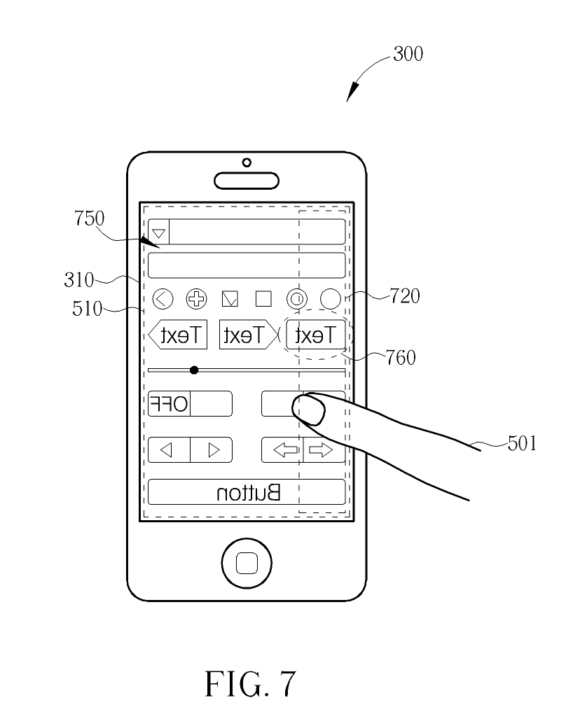

FIG. 7 is a diagram illustrating a scenario of displaying the second content 750 on the electronic device 300 shown in FIG. 3 based on the first content 550 shown in FIG. 5 according to a second implementation of the present disclosure. This implementation illustrates mirroring the first content 550 along a width (x-axis) of the electronic device 300 to generate the second content 750. In this implementation, after the receiving circuit 320 receives the user command, the controller 330 may control the display screen 310 to display the second content 750 on the first viewable display area 510 in the display screen 310 of the electronic device 300 instead of displaying the first content 550 on the first viewable display area 510 in the display screen 310 of the electronic device 300. Compared with the implementation shown in FIG. 6, this implementation does not resize the first content 550, but reverses/flips the first content 550 instead. In other words, the second content 750 is a mirrored version of the first content 550. In this way, the area of interest 760 (i.e. the mirrored version of “Text”) is now operable for one-handed operation, thus making some or all previously unreachable website links become reachable. This implementation can effectively reduce the difficulty of operating an unreachable area. For example, compared to original content normally displayed in the area 520 on the left side of the display screen 310, mirrored content displayed in the area 720 on the right side of the display screen 310 may become reachable for one-handed operations.

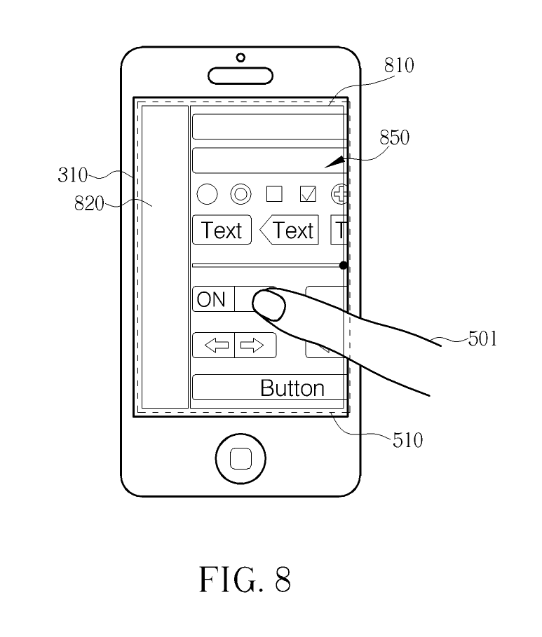

FIG. 8 is a diagram illustrating a scenario of displaying the second content 850 on the electronic device 300 shown in FIG. 3 based on the first content 550 shown in FIG. 5 according to a third implementation of the present disclosure. This implementation illustrates shifting the first content 550 along a width (x-axis) of the electronic device 300 to generate the second content 850.

In this implementation, after the receiving circuit 320 receives the user command, the controller 330 may control the display screen 310 to display the second content 850 on the second viewable display area 810 in the display screen 310 of the electronic device 300 instead of displaying the first content 550 on the first viewable display area 510 in the display screen 310 of the electronic device 300. Compared with the scenario shown in FIG. 6, this implementation may also resize the first content 550, but the generated second content 850 is not a down-scaled version of the first content 550. Compared with the first content 550, both the size and content of the second content 850 are different from those of the first content 550. Specifically, the second content 850 maybe generated by horizontally shifting the first content 550, e.g. the second content 850 can be viewed as the content formed by sliding the first content 550 or moving it to the right. In other words, the second content 850 is a truncated version of the first content 550, rather than a distorted/scaled version of the first content 550. In FIG. 8, after the second content 850 is generated by rightward sliding the first content 550, the area 820 may be left blank or utilized to show additional information, such as texts, pictures and/or weather forecast messages. This implementation may be modified to sliding the first content 550 or moving it to the left. Since one skilled in the art should readily know this modification after reading the above description, a detailed illustration thereof is omitted for brevity.

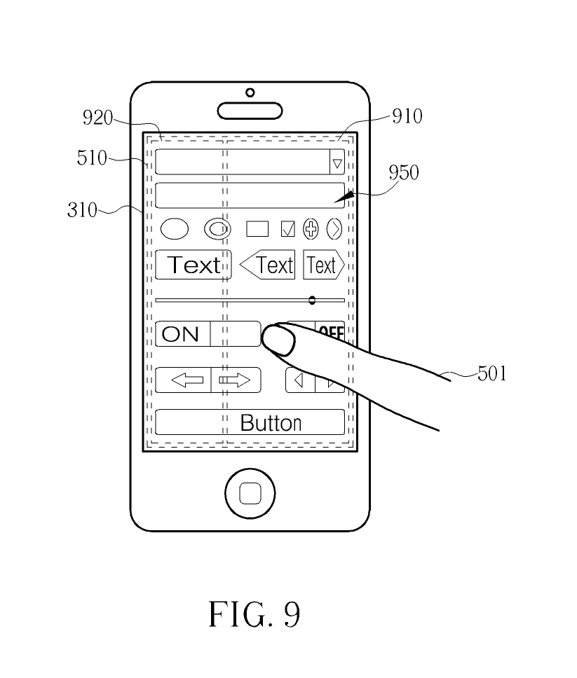

FIG. 9 is a diagram illustrating a scenario of displaying the second content 950 on the electronic device 300 shown in FIG. 3 based on the first content 550 shown in FIG. 5 according to a fourth implementation of the present disclosure. In this implementation, after the receiving circuit 320 receives the user command, the controller 330 may control the display screen 310 to display the second content 950 on the first viewable display area 510 in the display screen 310 of the electronic device 300 instead of displaying the first content 550 on the first viewable display area 510 in the display screen 310 of the electronic device 300. Compared with the implementation shown in FIG. 6, this implementation may not resize the first content 550, but may distort (e.g. nonlinearly scale) the first content 550 instead. For example, the content in the area 910 may be narrowed while the content in the area 920 may be widened. In this way, the area 820 is operable for one-handed operation, thus making some or all of the previously untouchable website links become touchable. This implementation can also effectively reduce the difficulty of operating an unreachable area.

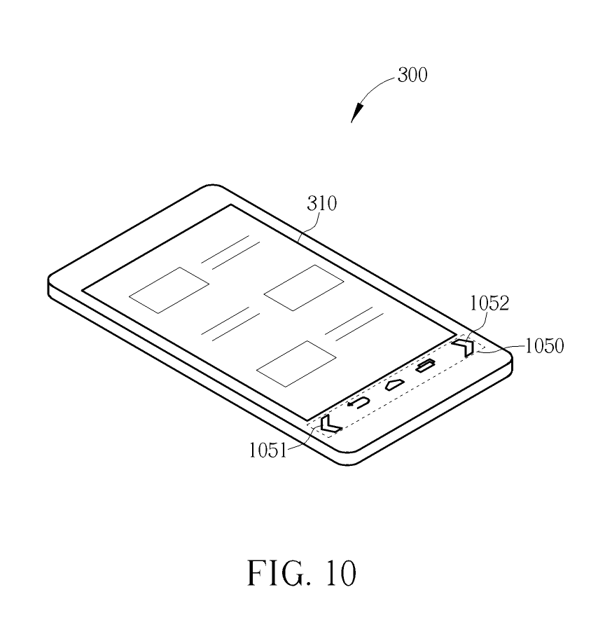

FIG. 10 is a diagram illustrating a scenario of generating a user command on the electronic device 300 shown in FIG. 3 according to a fifth implementation of the present disclosure. In this implementation, the user command is triggered by an operation upon at least one soft key displayed on the display screen 310. As shown in FIG. 10, there may be at least one soft key (e.g. soft keys 1051 and 1052) configured in the soft key area 1050. The soft keys 1051 and 1052 may be used to resize, mirror and/or distort the first content 550, and/or may be used to slide the first content 550 to the right or left, as mentioned in the previous implementations. Similar to the “home” key, the soft keys 1051 and 1052 can also be hidden when not being touched/enabled, and can be displayed when being touched.

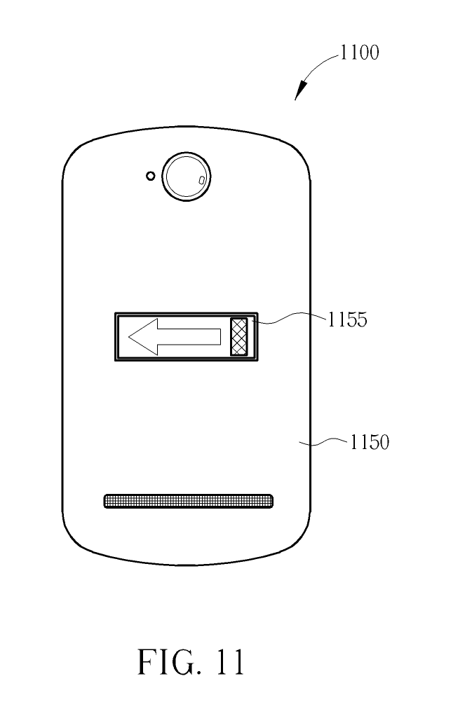

FIG. 11 is a diagram illustrating a scenario of generating a user command on an electronic device 1100 according to a sixth implementation of the present disclosure. The configuration of the electronic device 1100 maybe similar to that of the electronic device 300. For example, the electronic device 1100 may also include display screen 310, receiving circuit 320 and controller 330. Compared with the electronic device 300 shown in FIG. 3, the electronic device 1100 in this implementation may further include a physical key 1155 on its back cover 1150. The receiving circuit 320 of the electronic device 1100 may receive the user command generated/triggered by the physical key 1155, in order to enable the operations mentioned above, such as resizing, shifting, mirroring and/or distorting. The physical key 1155 may be a sliding bar that can be pushed or pulled by the thumb 501 to generate the user command, but the present disclosure is not limited thereto.

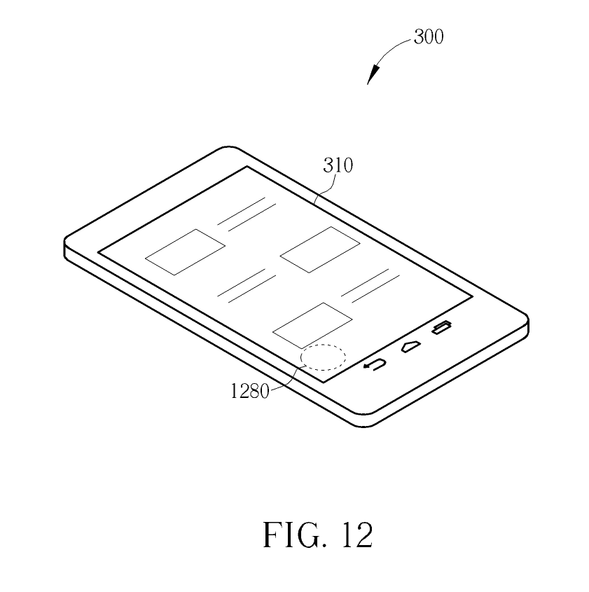

FIG. 12 is a diagram illustrating a scenario of generating a user command on the electronic device 300 shown in FIG. 3 according to a seventh implementation of the present disclosure. In this implementation, the user command may be triggered by an eye-tracking detection based on images generated by an image capture device (not shown) installed on the electronic device 300. For example, the image capture device may be a front camera, so an eye-tracking detection can be performed by the controller 330 through analyzing successive captured images to generate an eye-tracking detection result. For example, the user may stare at a specific area 1280 for a predetermined period to generate the user command in order to enable the operations mentioned above, such as resizing, shifting, mirroring and/or distorting

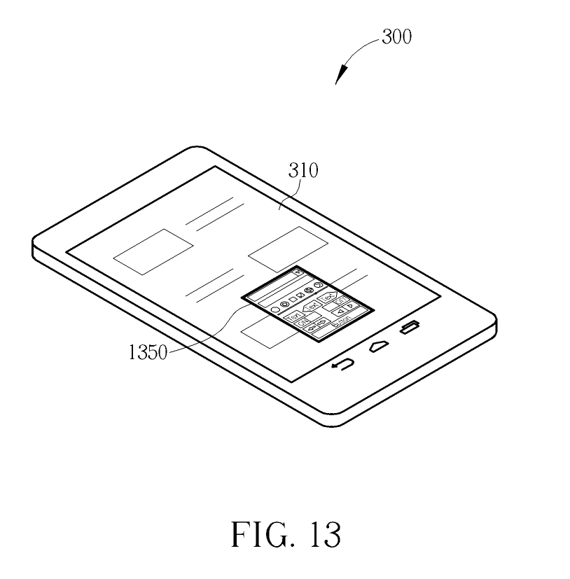

FIG. 13 is a diagram illustrating a scenario of displaying a floating window 1350 on the electronic device 300 shown in FIG. 3 based on the first content 550 shown in FIG. 5 according to an eighth implementation of the present disclosure. This implementation illustrates generating a floating window 1350 based on the first content 550, wherein the content shown in the floating window 1350 may be a resized/down-scaled version of the first content 550. The floating window 1350 can be moved and/or scaled, so that the user may easily perform operations upon some or all untouchable points of interest in the first content 550 by touching the corresponding points in the floating window 1350. Hence, this implementation can effectively reduce the difficulty of operating an unreachable area.

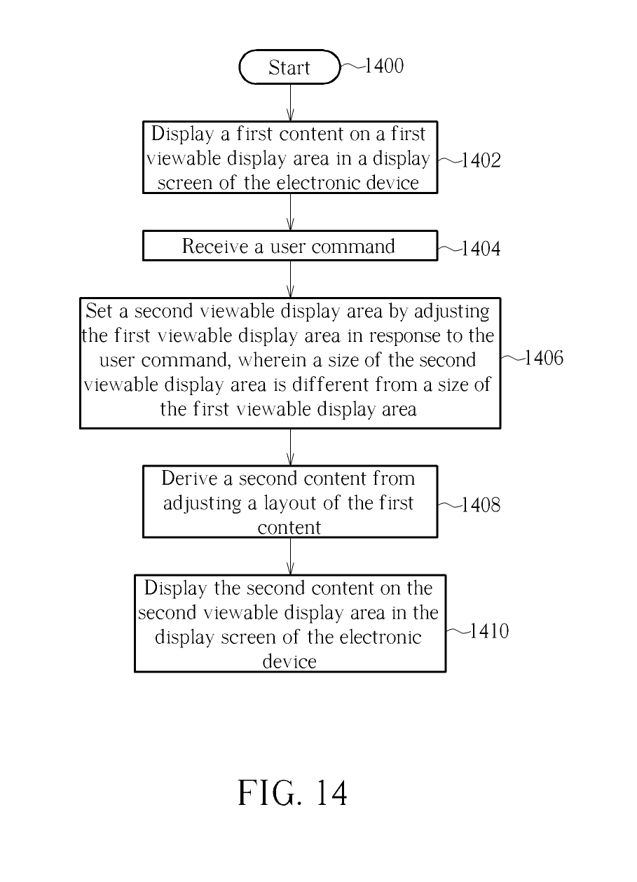

FIG. 14 is a flowchart illustrating a method of controlling an electronic device according to an implementation of the present disclosure. If the result is substantially the same, the steps are not required to be executed in the exact order shown in FIG. 14. The method shown in FIG. 14 may be employed by the electronic devices 300 and 1100 shown in FIGS. 3 and 11, respectively, and can be briefly summarized as follows.

Step 1400: Start;

Step 1402: Display a first content on a first viewable display area in a display screen of the electronic device;

Step 1404: Receive a user command;

Step 1406: Set a second viewable display area by adjusting the first viewable display area in response to the user command, wherein a size of the second viewable display area is different from a size of the first viewable display area;

Step 1408: Derive a second content from adjusting a layout of the first content; and

Step 1410: Display the second content on the second viewable display area in the display screen of the electronic device.

The above steps illustrate operations of the electronic devices 300 and 1100. As one skilled in the art can understand details of each step after reading the above paragraphs directed to the electronic devices 300 and 1100, further description is omitted here for brevity.

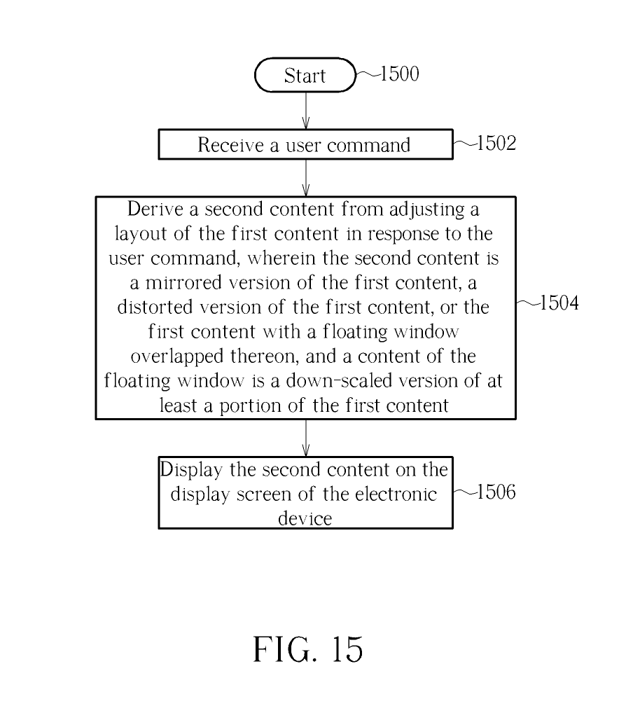

FIG. 15 is a flowchart illustrating a method of controlling an electronic device according to another implementation of the present disclosure. If the result is substantially the same, the steps are not required to be executed in the exact order shown in FIG. 15. The method shown in FIG. 15 may be employed by the electronic devices 300 and 1100 shown in FIGS. 3 and 11, respectively, and can be briefly summarized as follows.

Step 1500: Start;

Step 1502: Receive a user command;

Step 1504: Derive a second content by adjusting a layout of the first content in response to the user command, wherein the second content is a mirrored version of the first content, a distorted version of the first content, or the first content with a floating window overlapped thereon, and a content of the floating window is a down-scaled version of at least a portion of the first content; and

Step 1506: Display the second content on the display screen of the electronic device.

The above steps illustrate operations of the electronic devices 300 and 1100. As one skilled in the art can understand details of each step after reading the above paragraphs directed to the electronic devices 300 and 1100, further description is omitted here for brevity.

To summarize, through utilizing the implementations of the present disclosure, some points of interest of the content shown in the screen of an electronic device (especially a smartphone with a large screen) become more touchable/operable when performing one-handed operations without sacrificing the size of the electronic device. Hence, the user experience is greatly improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling an electronic device which displaying a first content on a first viewable display area in a display screen of the electronic device, comprising:
receiving a user command;
setting a second viewable display area by adjusting the first viewable display area in response to the user command, wherein a size of the second viewable display area is different from a size of the first viewable display area;
deriving a second content by adjusting a layout of the first content; and
displaying the second content on the second viewable display area in the display screen of the electronic device.

2. The method of claim 1, wherein receiving the user command comprises:
performing a gesture detection to generate a gesture detection result; and
identifying the user command according to the gesture detection result.

3. The method of claim 2, wherein performing the gesture detection comprises:
detecting tilting of the electronic device along a predetermined axis, wherein the predetermined axis represents a length of the electronic device.

4. The method of claim 1, wherein receiving the user command comprises:
receiving the user command generated by a soft key displayed on the display screen.

5. The method of claim 1, wherein receiving the user command comprises:
performing an eye-tracking detection to generate an eye-tracking detection result; and
identifying the user command according to the eye-tracking detection result.

6. The method of claim 1, wherein receiving the user command comprises:
receiving the user command generated by a physical key on a back cover of the electronic device.

7. The method of claim 1, wherein adjusting the layout of the first content comprises:
resizing the first content.

8. The method of claim 7, wherein resizing the first content comprises:
resizing the first content along a width of the electronic device.

9. The method of claim 1, wherein adjusting the layout of the first content comprises:
shifting the first content.

10. The method of claim 9, wherein shifting the first content comprises:
shifting the first content along a width of the electronic device.

11. The method of claim 1, wherein adjusting the layout of the first content comprises:
mirroring the first content.

12. A method of controlling an electronic device which displaying a first content on a display screen of an electronic device, comprising:
receiving a user command;
deriving a second content by adjusting a layout of the first content in response to the user command, wherein the second content is a mirrored version of the first content, a distorted version of the first content, or the first content with a floating window overlapped thereon, and a content of the floating window is a down-scaled version of at least a portion of the first content; and
displaying the second content on the display screen of the electronic device.

13. The method of claim 12, wherein receiving the user command comprises:
performing a gesture detection to generate a gesture detection result; and
identifying the user command according to the gesture detection result.

14. The method of claim 13, wherein performing the gesture detection comprises:
detecting tilting of the electronic device along a predetermined axis, wherein the predetermined axis represents a length of the electronic device.

15. The method of claim 12, wherein receiving the user command comprises:
receiving the user command generated by a soft key displayed on the display screen.

16. The method of claim 12, wherein receiving the user command comprises:
performing an eye-tracking detection to generate an eye-tracking detection result; and
identifying the user command according to the eye-tracking detection result.

17. The method of claim 12, wherein receiving the user command comprises:
receiving the user command generated by a physical key on a back cover of the electronic device.

18. An electronic device, comprising:
a display screen, arranged to display a first content on a first viewable display area or a second content on a second viewable display area;
a receiving circuit, arranged to receive a user command; and
a controller, arranged to set the second viewable display area by adjusting the first viewable display area in response to the user command, wherein a size of the second viewable display area is different from a size of the first viewable display area;
wherein the controller derives the second content by adjusting a layout of the first content, and controls the display screen to display the second content on the second viewable display area in the display screen of the electronic device instead of displaying the first content on the first viewable display area in the display screen of the electronic device when receiving the user command.

19. An electronic device, comprising:
a display screen, arranged to display a first content on a first viewable display area or a second content on a second viewable display area;
a receiving circuit, arranged to receive a user command; and
a controller, arranged to derive the second content by adjusting a layout of the first content in response to the user command, wherein the second content is a mirrored version of the first content, a distorted version of the first content, or the first content with a floating window overlapped thereon, where a content of the floating window is a down-scaled version of at least a portion of the first content;
wherein the controller controls the display screen to display the second content on the second viewable display area in the display screen of the electronic device instead of displaying the first content on the first viewable display area in the display screen of the electronic device when receiving the user command.
